(19) United States
(12) Patent Application Publication
(10) Pub. No.: US 2002/0107974 A1
(43) Pub. Date: Aug. 8, 2002

(54) Data traffic manager

(76) Inventors: Mark William Janoska, Carleton Place (CA); Henry Chow, Kanata (CA)

Correspondence Address: Shapiro Cohen, P.O. Box 3440, Station D, Ottawa, ON, K1P 6P1, CA

(21) Appl. No.: 09/969,599

(22) Filed: Oct. 4, 2001

Related U.S. Application Data
(60) Provisional application No. 60/238,025, filed on Oct. 6, 2000.

(51) Int. Cl. G06F 15/16

(52) U.S. Cl. 709/234; 709/225; 709/229

(57) ABSTRACT

Systems and methods for data traffic management in a node in a data network. A data path element receives data packets from the network and receives instructions from a buffer management element, coupled to the data path element, whether specific data packets are to be accepted for buffering or not. This decision is based on the status of a buffer memory bank coupled to the data path element. If a data packet is accepted, a data unit descriptor for that packet is queued for processing by a scheduler element coupled to the data path element. The scheduler element determines when a specific data packet is to be dispatched from the buffer memory bank based on the queued data unit descriptor.

The present invention relates to U.S. Provisional Patent Application 60/238,025 filed Oct. 6, 2000.

### FIELD OF THE INVENTION

This invention relates to methods and devices for managing data traffic passing through a node in a computer data network.

### BACKGROUND OF THE INVENTION

The field of computer networks has recently been inundated with devices that promise greater data handling capabilities. However, none of these innovations has addressed the issue of traffic management at a node level. In a node in a computer network, data traffic, packaged in data transmission units which may take the form of frames, packets or cells, can arrive at very high data influx rates.

This data traffic must be properly routed to its destinations and, unfortunately, such routing introduces delays. Accordingly, buffering the data traffic becomes necessary to allow such routing and other processing of data transmission units to occur. Concomitant with the concept of buffering the data is the necessity to manage the buffer memory and to contend with such issues as memory addressing and memory management. In addition to the delays introduced by routing, another possible bottleneck in the process is that of data outflow. While all incoming data traffic will be received at the input ports of the node, its output ports must be properly managed as some data traffic is considered more important than others, and should therefore be transmitted before other less important data is transmitted. Thus, in addition to the other functions listed above, priority determination between data transmission units must be performed so that priority data traffic can be dispatched to their destinations within an acceptable time frame.

When high data influx rates occur, managing the data traffic becomes difficult, especially when traffic management devices are integrated. Such integration used to be adequate for lower data influx rates as a single monolithic processor was used with appropriate programming, to manage the data traffic flow, to manage what little buffer memory was used, and to manage the outgoing data flow.

Such an approach is inadequate for nodes that will have data throughputs of 10 Gb/s, or more. A single processor solution is unlikely to be able to cope with the data influx and is unlikely to be able to properly route traffic within the time and the data throughput requirements. Furthermore, such a monolithic approach does not easily lend itself to scalability as the single processor is tied to its own clock speed, data throughput, and data bus limitations.

From the above, there is therefore a need for a computer networking data traffic management system that can be upwardly scalable in both size, and data influx rates and can accomplish the required functions within the requirements of high data influx rates.

### SUMMARY OF THE INVENTION

The present invention seeks to provide systems and methods for data traffic management in a node in a data network. A data path element receives data packets from the network and receives instructions from a buffer management element, coupled to the data path element, whether specific data packets are to be accepted for buffering or not. This decision is based on the status of a buffer memory bank coupled to the data path element. If a data packet is accepted, a data unit descriptor for that packet is queued for processing by a scheduler element coupled to the data path element. The scheduler element determines when a specific data packet is to be dispatched from the buffer memory bank based on the queued data unit descriptor.

In a first aspect, the present invention provides a method of managing data traffic through a node in a network, the method comprising: (a) receiving a data transmission unit at a data path element, (b) extracting header data from a received data transmission unit, (c) transmitting extracted header data to a buffer management element, (d) at the buffer management element, accepting or rejecting the received data transmission unit based on the extracted header data, (e) if the received data transmission unit is accepted, at the buffer management element, allocating storage space in a buffer memory bank for the received data transmission unit and recording that the storage space for the data transmission unit is occupied, (f) at the data path element referred to in step a), storing the received data transmission unit in the buffer memory, (g) storing the data transmission unit in the buffer memory bank, (h) creating a unit descriptor in the data path element, the unit descriptor containing data related to the data transmission unit including priority data for the data transmission unit, (i) placing the unit descriptor in a service queue of earlier unit descriptors, (j) at a scheduler element, retrieving a queued unit descriptor from the service queue, (k) scheduling a departure from the data path element of the data transmission unit corresponding to the queued unit descriptor, the scheduling being based on priority data for the data transmission unit corresponding to the queued unit description, and (e) for each data transmission unit schedule for a departure from the data path element, (l1) retrieving from said buffer memory the data transmission unit schedule for departure, (l2) despatching from the data path element the data transmission unit scheduled for departure, and (l3) updating records at the buffer management element to indicate that storage space vacated by a dispatched data transmission unit is available.

In a second aspect, the present invention provides a system for managing data traffic through a node in a network, the system comprising: a data path element (DPE) module for receiving and transferring discrete data transmission units containing data, a buffer management element (BME) module for managing at least one buffer memory bank coupled to the DPE for buffering data transmission units received by the DPE, the BME being coupled to the DPE, and a scheduler element (SCE) coupled to the DPE for scheduling departures of data transfer units buffered in the at least one buffer memory bank from the system.

In a third aspect, the present invention provides a method of managing data traffic through a node in a network, the method comprising: (a) receiving a data transmission unit at a data path element in the node, (b) extracting header data from the data transmission unit, the header data including priority data and connection data related to the data transmission unit, (c) accepting or rejecting the data transmission unit based on extracted header data at a buffer management element coupled to the data path element, (d) if the data transmission unit is accepted, storing the data transmission unit in a buffer memory coupled to the data path element, a storage location for the data transmission unit being determined by the buffer management element, (e) placing a unit descriptor in a service queue, the unit descriptor corresponding to the data transmission unit stored in step (d), the unit descriptor containing data including the priority data extracted in step (b), (f) sequentially processing each unit descriptor in the service queue such that each data transmission unit corresponding to a unit descriptor being processed is scheduled for dispatch to a destination, each data transmission unit being scheduled for dispatch based on the priority data in a unit descriptor corresponding to the data transmission unit, the processing of each media descriptor being executed by a scheduler element, (g) processing each data transmission unit scheduled for dispatch according to a schedule as determined in step (f), the processing of each data transmission unit including: (f1) retrieving the data transmission unit from the buffer memory, (f2) informing the buffer management element of a retrieval of the data transmission unit from the buffer memory, (f3) dispatching the data transmission element to a destination from the data path element.

In a fourth aspect, the present invention provides a system for managing data traffic through a node in a network, the system comprising a plurality of physically separate modules, the modules comprising: a data path element module receiving and dispatching data transmission units, a buffer management element module managing at least one buffer memory bank coupled to the data path element module, the buffer management element module being coupled to the data path element module, a scheduler element module scheduling dispatch of data transmission units from the data path element module to a destination, the scheduler element module being coupled to the data path element module.

### BRIEF DESCRIPTION OF THE DRAWINGS

A better understanding of the invention may be obtained by reading the detailed description of the invention below, in conjunction with the following drawings, in which:

FIG. 1 is a block diagram of a system for managing data traffic in a mode in a data network,

FIG. 2 illustrates a block diagram detailing the dates structures maintained within the different elements,

FIG. 3 is a block diagram of a configuration for a buffer management element,

FIG. 4 is a block diagram of a configuration of the scheduler element, and

FIG. 5 is a flow chart detailing the steps executed by the system in FIG. 1 in managing data traffic.

### DETAILED DESCRIPTION OF THE INVENTION

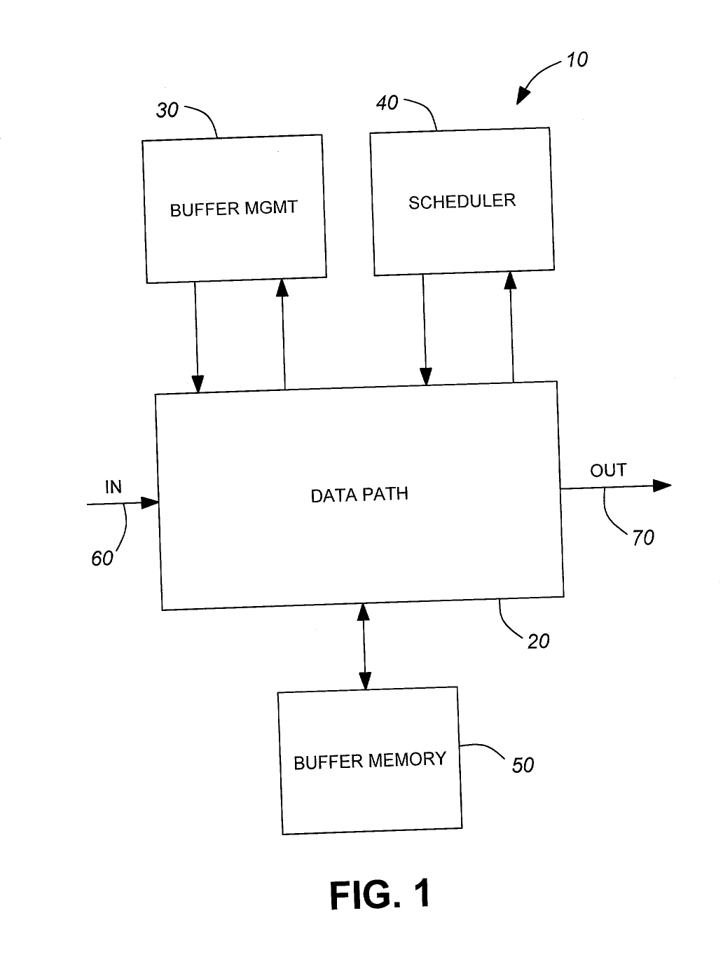

Referring first to FIG. 1, a block diagram of a system 10 for managing data traffic in a node in a data network is illustrated. A data path element (DPE) 20 is coupled to a buffer management element (BME) 30, a scheduler element (SCE) 40, and a buffer memory bank 50.

The data path element 20 receives data transmission units as input at 60 and, similarly, transmits data transmission units as output at 70. It should be noted that the term data transmission unit (DTU) will be used in a generic sense throughout this document to mean units used to transmit data. Thus, such units may be packets, cells, frames, or any other unit as long as data is encapsulated within the unit. Thus, the invention described below is applicable to any and all packets or frames that implement specific protocols, standards or transmission schemes.

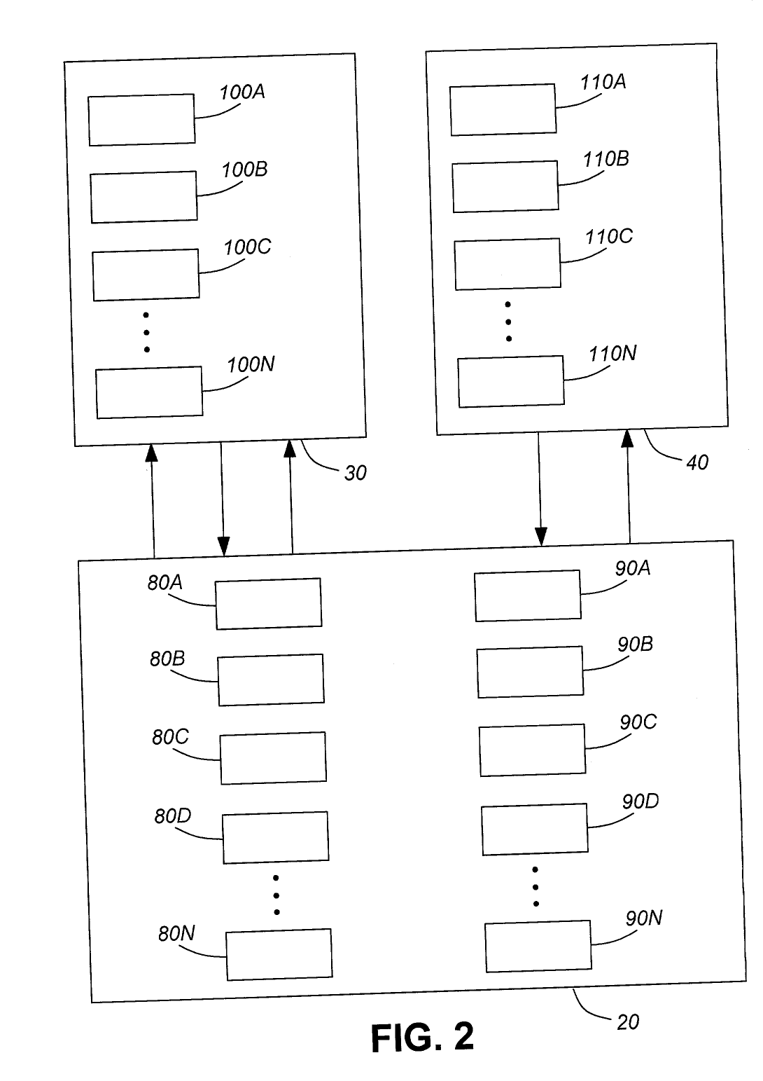

Referring now to FIG. 2, data structures maintained within the different elements are described. Within the DPE 20 are connection queues 80A, 80B, 80C . . . 80N and queues 90A, 90B, 90C, 90D. Maintained within the BME 30 are connection resource utilization data structures 100A, 100B, 100C . . . 100N. Also, maintained within the SCE 40 are service queue scheduling data structures 110A, 110B, 110C . . . 110N.

Each arriving DTU has a header which contains, as a minimum, the connection identifier (Cl) for the arriving DTU. The connection identifier identifies the connection to which the DTU belongs. When each arriving DTU is received by the DPE, the header for the arriving DTU is extracted and processed by the DPE. Based on the contents of the header, the arriving DTU is sent to the connection queue associated with the connection to which the arriving DTU belongs. There is therefore one connection queue for each connection transmitting through the system 10.

Once the arriving DTU is queued, each member of that queue is, in turn, processed by the DPE. Once the queued DTU is processed, it is removed from the queue. This processing involves notifying the BME that a new DTU has arrived and sending the details of the DTU to the BME. The BME then decides whether that DTU is to be buffered or not. The decision to buffer or not may be based on numerous criteria such as buffer memory space available congestion due to a high influx rate of incoming DTUs, or output DTU congestion. If the DTU is not to be buffered, then the DTU is discarded. If the DTU is to be buffered, then the BME, along with its decision for buffering the DTU, sends to the DPE the addressing details for buffering the DTU. The DPE then sends the DTU to the buffer memory 50 using the BME supplied addressing data. This addressing data includes the memory address in the buffer memory where the DTU is to be stored.

At the same time as the DPE is buffering the DTU, a unit descriptor for that buffered DTU is created by the DPE. The unit descriptor includes not only the header data from the buffered DTU but also the priority data for the buffered DTU and the buffer memory addressing information. Each unit descriptor created by the DPE is then queued in one of the services queues 90A . . . 90N. A service queue for a unit descriptor is chosen based on the priority data for a particular buffered DTU as represented by a unit descriptor. Thus, each service queue will have a certain priority or service rating associated with it. Any unit descriptor added to a service queue will have the same service rating or priority rating as the service queue.

Once a unit descriptor is added to a service queue, that unit descriptor waits until it is processed by the SCE. When a unit descriptor advances to the head of a service queue, details regarding that unit descriptor, such as in the identification of its service queue, is transmitted to the SCE. The SCE then determines when the DTU represented by the unit descriptor may be dispatched out of the system 10.

If a buffered DTU, as represented by a unit descriptor, is scheduled for dispatch, then the SCE transmits the details regarding the exiting unit descriptor to the DPE. The DPE receives these details, such as the service queue containing the exiting unit descriptor, and retrieves the relevant exiting unit descriptor. Then, based on the addressing information in the unit descriptor, the DTU is retrieved from buffer memory by the DPE and routed to an exit port for transmission. Once the DTU is retrieved from buffer memory, a message is transmitted to the BME so that the BME may update its records regarding the DTU about to be dispatched and the now available space in the buffer memory just vacated by the exiting DTU.

The BME, as noted above, manages the buffer memory. The BME does this by maintaining a record of the DTUs in the buffer memory, where those DTUs are, and deciding whether to accept more DTUs for buffering. This decision regarding accepting more DTUs for buffering is based on factors such as the state of the buffer memory and the priority of the incoming DTU. If the buffer memory is sparsely utilized, incoming DTUs are received and accepted on a first-come, first-served basis. However, once the buffer memory utilization reaches a certain point, such as 50%, then only incoming DTUs with a certain priority level or higher are accepted for buffering. The BME may also, if desired, be configured so that the minimum DTU priority level increases as the buffer memory utilization increases.

From FIG. 2, and as noted above, the BME maintains numerous connection resource data structures 100A, 100B . . . 100N. Each data structure records how much of the buffer memory is used by a specific connection. If a specific connection uses more than a specific threshold percentage of the buffer memory, then incoming DTUs from that connection are to be rejected by the BME. These data structures may take the form of counters or stacks which are incremented when an incoming DTU is accepted for buffering and which are decremented when an exiting DTU is removed from the buffer memory.

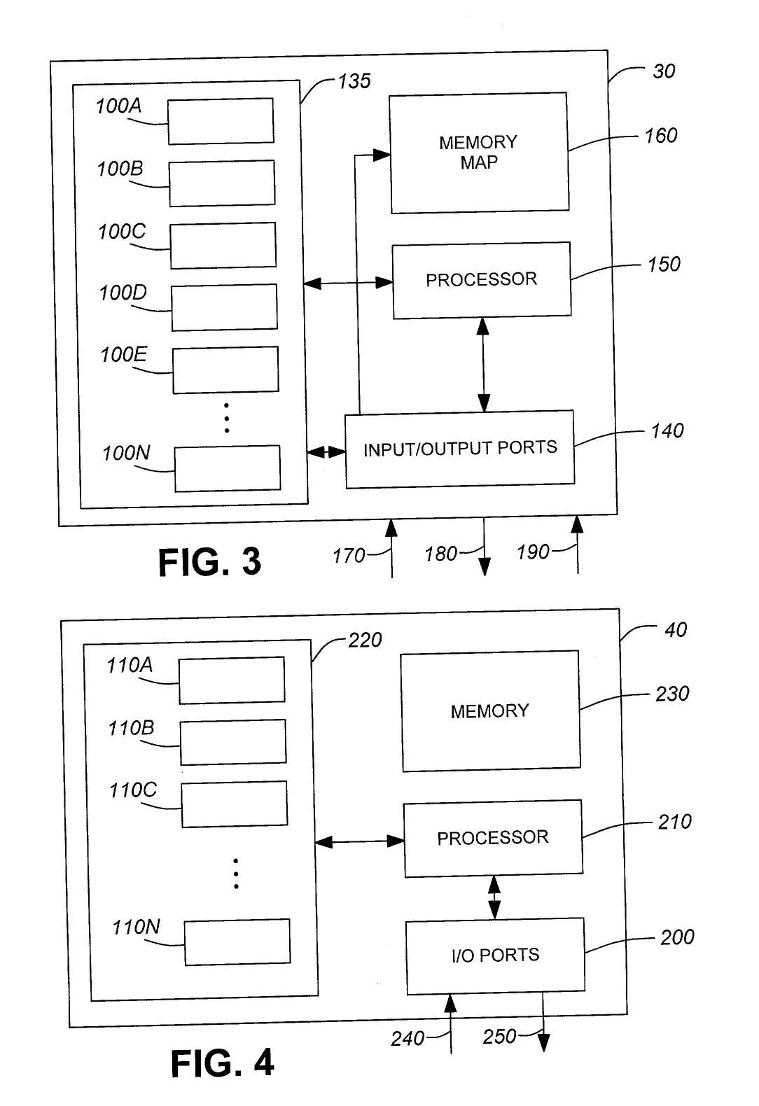

Referring to FIG. 3, a block diagram of a possible configuration for the BME 30 is illustrated. A connection resource utilization section 135 contains the connection resource utilization data structures 100A, . . . 100N. Input/output (I/O) ports 140 receive and transmit data to the DPE by way of unidirectional ports. A processor 150 receives data from the I/O ports 140, data structures section 135, and a memory map 160. The memory map 160 is a record of which addresses in the buffer memory are occupied by buffered DTUs and which addresses are available.

The processor 150, when notification of an arriving DTU is received, determines to which connection the arriving DTU belongs. Based on this information, the processor 150 then checks the resource utilization section 135 for the resource utilization status for that connection, i.e. has the connection exceeded its limit. At around the same time, the processor also checks the memory map 160 for the status of the buffer memory as a whole, to determine whether there is sufficient space available in the buffer memory? Based on the data gathered by these checks, the processor 150 then decides whether to accept the arriving DTU or not. If a decision to reject is made, a reject message, identifying the connection affected, is sent to the DPE through the I/O ports 140. If, on the other hand, a decision to accept is made, the processor 150 retrieves an available buffer memory address from the memory map 160 and, along with the accept decision, transmits this available address to the DPE.

The processor 150 then increments the relevant connection resource utilization data structure in the connection resource utilization section 135 to reflect the decision to accept. As well, the processor 150 marks the memory address sent to the DPE as being used in the memory map 160.

If a dispatch request is received by the I/O ports 140 indicating that an exiting DTU is being dispatched from the buffer memory, the processor 150 also receives this request. The processor 150 then determines which DTU is being dispatched from the dispatch request message. The address occupied by this DTU, determined either from the dispatch request message received from the DPE or from the memory map, is then marked as free in the memory map. Also, the relevant connection resource utilization data structure is decremented to reflect the dispatch of a DTU for that connection.

The BME may communicate with the DPE through three dedicated unidirectional ports. An arrival request port 170 receives arrival notification of incoming DTUs. An arrival grant port 180 transmits accept or reject decisions to the DPE, and a departure request port 190 receives dispatch notification of exiting DTUs. While three ports are illustrated in FIG. 3, the three ports do not necessarily require three physical ports. If desired, the signals that correspond to each of the three ports can be multiplexed into any number of data links between the DPE and the BME. For each of the ports 170, 180, 190, transmissions may have multiple sections. Thus, transmissions may have a clock signal for synchronizing between a data transmitter and a data receiver, an n-bit data bus by which data is transmitted, a start-of-transmission signal for synchronizing a specific data transmission, and a back pressure signal that is an indication of data or transmissions that are backlogged.

The SCE, as noted above, handles the scheduling dispatching buffered DTUs. A block diagram of a possible configuration of the SCE is illustrated in FIG. 4. The service queues 90A . . . 90N in the DPE each correspond to a priority level that is tracked by the SCE. As the SCE receives notification of arriving unit descriptors at the service queues, the SCE determines how much of the outgoing data transmission capacity of the system is to be dedicated to a specific priority level. To this end, the service queue servicing data structures 110A . . . 110N in the SCE are maintained. Each unit descriptor arriving at a service queue in the DPE will have a corresponding counterpart in the relevant service queue data structure in the SCE. It must be noted that a unit descriptor arriving at a service queue occurs when the unit descriptor is at the head of that particular service queue and not when the unit descriptor is inserted at the tail of the service queue. Arrival at a service queue, and indeed in any of the queues mentioned in this document, means when a unit, either a unit descriptor or a DTU, is at the head of its particular queue and the relevant element is notified of the presence of that unit at the head of a queue.

Based on the above, a unit descriptor can then arrive at a service queue and the SCE will be notified of this arrival. A corresponding counterpart to the unit descriptor will then be created in the SCE subsequent to the transmission of the unit descriptor's control data and characteristics to the SCE. The SCE will then store this corresponding counterpart in the relevant service queue data structure in the SCE. The SCE will then decide which DTUs are to be dispatched, and in what sequence based on the status of the service queue data structures and on the status of the output ports of the system. As an example, if service queue data structures corresponding to priority levels 5 and 6 are almost full while service queue data structures corresponding to priority level 4 has only one entry, the SCE may decide to dispatch DTUs with priority level 5 or 6 instead of DTUs with priority level 4.

When dispatching DTUs represented by unit descriptors and their counterparts in the SCE, the SCE transmits to the DPE the identity of the DTU to be dispatched. Prior to, or just subsequent to this transmission, the SCE removes the unit descriptor counterpart of this exiting DTU from the service queue data structure in the SCE. This action updates these data structures as to which DTUs are in queue for dispatching.

Similar to the connection resource utilization data structures in the BME, the service queue data structures may take the form of stacks with the unit descriptor counterparts being added and removed from the stacks as required. From this, a configuration of the SCE may be as that illustrated in FIG. 4. I/O ports 200 communicate with the DPE while a processor 210 receives and sends transmissions to the DPE through the I/O ports 200. The processor 210 also communicates with a service queue data structure section 220 and a memory 230. The service queue data structure section 220 contains the service queue data structures 110A . . . 110N while the memory 230 contains the details regarding the unit descriptor counterparts which populate the service queue data structures 110A . . . 110N. The I/O ports 200 operate in a manner similar to the I/O ports 140 in the BME, the main difference being the number of the ports. For the SCE, only two unidirectional ports are required. An arrival request port 240 receives the notifications of unit descriptors arriving at a service queue. The details regarding such arriving unit descriptors are also received through the arrival request port 240. Instructions to the DPE to dispatch a DTU from the buffer memory are transmitted through the departure request port 250.

To recount the process which the SCE undergoes when a unit descriptor arrives at a service queue, the I/O ports 200, through the arrival request port 240, receive the unit descriptor arrival notification along with the control data associated with the unit descriptor. This data and the notification is sent to the processor 210 for processing. The processor 210 then increments the relevant service queue data structure in the service queue data structure section 220 and stores the information for that unit descriptor in the memory 230. When the processor decides, based on the status of the conditions in the system as indicated by the service queue data structures, to dispatch a buffered DTU, the processor 210 retrieves the data related to that DTU as transmitted to the processor by way of the unit descriptor arrival notification. This data is retrieved from the memory 230 and the relevant service queue data structure is decremented by the processor. This same data is then transmitted for the DPE by way of the departure request port 250.

Once this data is received by the DPE, as noted above, the DPE retrieves the DTU from the buffer memory, notifies the BME, and dispatches the DTU.

It should be noted that once a unit descriptor arrives at a service queue or, as explained above, moves to the head of a service queue, the SCE is notified of this arrival. Once the notice is sent to the SCE along with the required information regarding the unit descriptor, the unit descriptor is removed from the service queue in the DPE.

A similar process applies to the connection queues 80A . . . 80N in the DPE. Once a DTU arrives at the head of a connection queue, its control data is sent to the BME. Once the BME sends a decision regarding that DTU, the DTU is removed from the connection queue. If the decision is to buffer the DTU, a unit descriptor is created and the DTU is sent to the buffer memory. On the other hand, if the DTU is to be rejected, the DTU is simply removed from the connection queue and the data in the DTU and the control data related to that DTU is discarded.

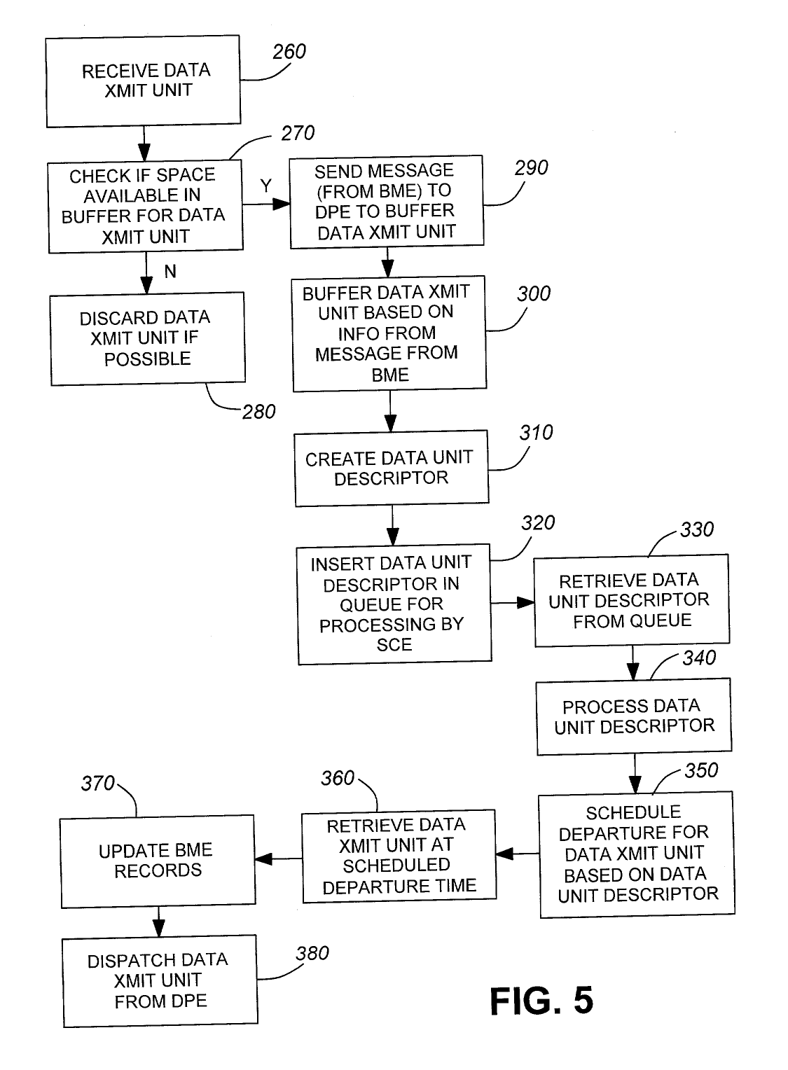

Referring to FIG. 5, a flow chart detailing the steps executed by the system 10 is illustrated. The process begins with step 260, that of the system 10 receiving a data transmission unit or a DTU. Once the DTU has been received by the DPE or data path element, it is placed in a connection queue for later processing by the BME. The BME then executes step 270, to check if space is available in the buffer memory for the data transmission unit for a specific connection. If space is not available, then step 280 is implemented, and eh DTU is discarded. If, on the other hand, space is available in the buffer memory for the DTU that has arrived, then the BME executes step 290, and sends a message to the DPE to buffer the data transmission unit in the buffer memory. As part of step 290 the BME transmits to the DPE the details regarding the area in which the data transmission unit is to be buffered. Also, as part of step 290 the BME updates its records its connection queue data structures and its memory map to reflect the fact that a new data transmission unit has been buffered in the buffer memory.

Once the above has been executed, the DPE then executes step 300, and buffers the data transmission unit based on the information received from the BEM. The data transmission unit is therefore sent to the buffer memory to be buffered in the location denoted by the address sent by the BME to the DPE. After step 300, the DPE then creates a data unit descriptor (step 310) for the data transmission unit that has just been buffered. In step 320, the unit descriptor that has just been created is inserted in a service queue for later processing by the SCE. Step 330 is executed whenever a unit descriptor reaches the head of a service queue. As can be seen in FIG. 5, step 330 is that of retrieving the unit descriptor from the queue, and step 340 is that of processing the unit descriptor. Step 340 involves sending the data that is in the unit descriptor to the SCE so that the SCE may decide when the data transmission unit that is represented by the data unit descriptor can be scheduled for dispatch from the traffic management system 10. Step 350 is executed by the SCE as it is the actual scheduling of the departure or dispatch of the data transmission unit based on information or data stored in the unit descriptor that has just been received by the SCE. After a dispatch time or departure time for the data transmission unit has been determined by the SCE, step 360 is that of retrieving the data transmission unit at the scheduled dispatch departure time from the buffer memory. Step 360 is executed by the DPE after the DPE has been notified by the SCE of the scheduled departure time of the data transmission system. Once the data transmission unit has been retrieved from the buffer memory by the DPE, step 370 is that of notifying the BME that a data transmission unit has been retrieved from the buffer memory and is to be dispatched. This step allows the BME to update its records that a data transmission unit has just been removed from the buffer memory. The final step in the process is that of step 380. Step 380 actually dispatches a data transmission unit from the DPE and therefore from the traffic management system 10.

We claim:

1. A method of managing data traffic through a node in a network, the method comprising:
(a) receiving a data transmission unit at a data path element,
(b) extracting header data from a received data transmission unit,
(c) transmitting extracted header data to a buffer management element,
(d) at the buffer management element, accepting or rejecting the received data transmission unit based on the extracted header data,
(e) if the received data transmission unit is accepted, at the buffer management element, allocating storage space in a buffer memory bank for the received data transmission unit and recording that the storage space for the data transmission unit is occupied,
(f) at the data path element referred to in step a), storing the received data transmission unit in the buffer memory,
(g) storing the data transmission unit in the buffer memory bank,
(h) creating a unit descriptor in the data path element, the unit descriptor containing data related to the data transmission unit including priority data for the data transmission unit,
(i) placing the unit descriptor in a service queue of earlier unit descriptors,
(j) at a scheduler element, retrieving a queued unit descriptor from the service queue,
(k) scheduling a departure from the data path element of the data transmission unit corresponding to the queued unit descriptor, the scheduling being based on priority data for the data transmission unit corresponding to the queued unit description, and
(l) for each data transmission unit schedule for a departure from the data path element,
(l1) retrieving from said buffer memory the data transmission unit schedule for departure,
(l2) despatching from the data path element the data transmission unit scheduled for departure, and
(l3) updating records at the buffer management element to indicate that storage space vacated by a dispatched data transmission unit is available.

2. A system for managing data traffic through a node in a network, the system comprising:
a data path element (DPE) module for receiving and transferring discrete data transmission units containing data,
a buffer management element (BME) module for managing at least one buffer memory bank coupled to said DPE for buffering data transmission units received bny the DPE, said BME being coupled to said DPE, and
a scheduler element (SCE) coupled to the DPE for scheduling departures of data transfer units buffered in the at least one buffer memory bank from the system.

3. A method of managing data traffic through a node in a network, the method comprising:
(a) receiving a data transmission unit at a data path element in the node,
(b) extracting header data from the data transmission unit, the header data including priority data and connection data related to the data transmission unit,
(c) accepting or rejecting the data transmission unit based on extracted header data at a buffer management element coupled to the data path element,
(d) if the data transmission unit is accepted, storing the data transmission unit in a buffer memory coupled to the data path element, a storage location for the data transmission unit being determined by the buffer management element,
(e) placing a unit descriptor in a service queue, the unit descriptor corresponding to the data transmission unit stored in step (d), the unit descriptor containing data including the priority data extracted in step (b),
(f) sequentially processing each unit descriptor in the service queue such that each data transmission unit corresponding to a unit descriptor being processed is scheduled for dispatch to a destination, each data transmission unit being scheduled for dispatch based on the priority data in a unit descriptor corresponding to the data transmission unit, the processing of each media descriptor being executed by a scheduler element,
(g) processing each data transmission unit scheduled for dispatch according to a schedule as determined in step (f), the processing of each data transmission unit including:
(f1) retrieving the data transmission unit from the buffer memory,
(f2) informing the buffer management element of a retrieval of the data transmission unit from the buffer memory,
(f3) dispatching the data transmission element to a destination from the data path element.

4. A system for managing data traffic through a node in a network, the system comprising a plurality of physically separate modules, the modules comprising:
a data path element module receiving and dispatching data transmission units,
a buffer management element module managing at least one buffer memory bank coupled to the data path module, the buffer management module being coupled to the data path module,
a scheduler element module scheduling dispatch of data transmission units from the data path element module to a destination, the scheduler element module being coupled to the data path element module.
